(19) United States
(12) Patent Application Publication
(10) Pub. No.: US 2026/0320527 A1
(43) Pub. Date: Oct. 15, 2026

(54) METHOD AND ELECTRONIC DEVICE FOR HANDLING AUTOMATIC PRODUCT DEVELOPMENT LIFECYCLE PROCESS

(71) Applicant: HUMANIZE BUSINESS SOLUTIONS PRIVATE LIMITED, West Bengal (IN)

(72) Inventors: Jagdish Mitra, West Bengal (IN); Raja Roy, West Bengal (IN); Sandip Jha, West Bengal (IN); Subhasis Chakraborty, West Bengal (IN); Hariharamoorthy Theriappan, West Bengal (IN); Somprav Pareek, West Bengal (IN)

(21) Appl. No.: 19/645,041

(22) Filed: Apr. 10, 2026

(30) Foreign Application Priority Data
Apr. 11, 2025 (IN) 202531035675

(51) Int. Cl. G06Q 10/0633

(52) U.S. Cl. CPC G06Q 10/0633

(57) ABSTRACT

The embodiments herein achieve a product development lifecycle process automation controller (140) that enables enterprises to go-to-market faster. The product development lifecycle process automation controller (140) do it through a proprietary platform, a humanAIze platform (for example), leveraging artificial intelligence (AI), GenAI, Agentic AI and Data Science. The platform is a collection of systems, tools and logics that enables faster deployment of Low-code/No-code SaaS platforms by automating more than 60% of manual labor intensive activities across the implementation cycle, making it ~30% or above faster.

### CROSS REFERENCE TO RELATED APPLICATION

This application is based on and derives the benefit of Indian Provisional Application 202531035675, the contents of which are incorporated herein by reference.

### TECHNICAL FIELD

Embodiments disclosed herein relate to a product development lifecycle process management method and system, and more specifically to, a method and an electronic device for handling automatic product development lifecycle process.

### BACKGROUND

According to various industry reports, Enterprise Resource Planning and SaaS (Software as a Service) projects, including System Applications and Products such as SAP), Salesforce, ServiceNow or the like, have a high failure rate, with some studies suggesting that 50% to 75% (for example) fail to meet expectations around time and cost of implementation, migration and development. Additionally, over 50% of enterprise resource planning (ERP) projects are slightly or significantly delayed. Further, 63% of organizations used moderate or heavy customizations in their ERP and SaaS projects to fit their processes. For midsize companies, the maintenance cost of ERP systems is approximately 3-5% of annual revenue (SAP, Netsuite, Salesforce (for example)). Approximately 50% of SaaS implementations fail to achieve their intended objectives, often due to inadequate planning and execution, understanding of existing code base, ability to translate business requirements into technology solutions faster, and most importantly knowledge arbitrage for a complete manpower dependent model of the IT services. Delivering SaaS and ERP implementations on time, and with quality for faster value realization to business is the problem statement. Hence, Artificial intelligence (AI) is set to disrupt the conventional business model of IT services, which is manpower, skill and knowledge intensive by automating manpower-driven repetitive IT tasks and delivering software services as a packaged software (such as configurations, developments, testing) and augmenting knowledge-driven IT tasks (such as design, recommendation, knowledge based guidance) delivering software services as a packaged software. This helps to eliminate dependency on talent, knowledge, standard methods of SaaS and ERP implementations. It replaces the cost arbitrage business model of conventional IT services and leverages talent plus technology, delivered through A Software product, in the future. This model of delivering technology services through an automated Product is called ‘Services as a Software’.

Hence, there is a need in the art for solutions which will overcome the above mentioned drawback(s), among others.

### SUMMARY

Accordingly, the embodiments herein provide a method for handling autonomous development lifecycle process for an enterprise application package (e.g., packaged business application, integrated enterprise application system, enterprise application platform, business process application suite or the like). The method includes receiving, by an electronic device, an input for configuring a product development lifecycle process. Further, the method includes processing, by the electronic device, the input to identify at least one task from a plurality of tasks for configuring the product development lifecycle process using at least one data driven model. Further, the method includes automating, by the electronic device, the product development lifecycle process based on at least one identified task from the plurality of tasks.

Accordingly, the embodiments herein provide an electronic device for handling autonomous product development lifecycle process. The electronic device includes a product development lifecycle process automation controller coupled with a processor and a memory. The product development lifecycle process automation controller is configured to receive a set of unstructured input for configuring a product development lifecycle process. The product development lifecycle process automation controller is configured to process the input to identify at least one task from a plurality of tasks for configuring the product development lifecycle process using at least one data driven model. The product development lifecycle process automation controller is configured to automate the product development lifecycle process based on the at least one identified task from the plurality of tasks.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF FIGURES

The embodiments disclosed herein are illustrated in the accompanying drawings, throughout which like reference letters indicate corresponding parts in the various figures. The embodiments herein will be better understood from the following description with reference to the drawings, in which:

FIG. 1 is a block diagram of an electronic device including a product development lifecycle process automation controller (e.g., SaaS agnostic platform or the like), that delivers ‘Services as Software’ across all products, according to embodiments as disclosed herein; and

FIG. 2 is an example scenario in which operations of the product development lifecycle process automation controller (e.g., SaaS agnostic platform or the like) is explained, according to embodiments as disclosed herein;

FIG. 3 is an example illustration in which an orchestrating multi-agent workflows with reasoning, retrieval, guardrails, and tool integration, according to embodiments as disclosed herein;

FIG. 4 illustrates an architectural overview of the platform, according to embodiments as disclosed herein;

FIG. 5 is a flow chart illustrating a method for handling automatic product development lifecycle process, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The principal object of the embodiments herein is to disclose a SaaS agnostic platform, that delivers ‘Services as Software’ across all products. The SaaS agnostic platform (or humanAIze platform (for example)) is one of a world's first ‘Services as Software’ platform that uses deep-tech to package software services and automates software implementation. The platform minimizes human dependency, maximize efficiency, focuses on outcome by leveraging AI/GenAI technologies for making SaaS implementation touchless.

The embodiments herein achieve a product development lifecycle process automation controller (e.g., SaaS agnostic platform or the like) that enables enterprises to go-to-market faster. The product development lifecycle process automation controller do it through a proprietary platform, humanAIze platform (for example), leveraging artificial intelligence (AI), GenAI, Agentic AI and Data Science. The platform is a collection of systems, tools and logics that enables faster deployment of Low-code/No-code SaaS platforms by automating more than 60% of manual labor intensive activities across the implementation cycle, making it ~50% or above faster (for example).

The humanAIze platform is one of the world's first ‘Services as a Software’ platform that uses deep-tech to package software services and automates software implementation. The humanAIze platform minimizes human dependency, maximize efficiency, focuses on outcome by leveraging AI/GenAI technologies for making various steps of SaaS implementation touchless.

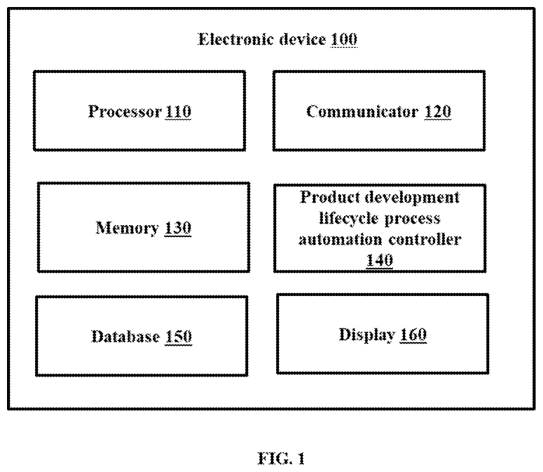

Referring now to the drawings, and more particularly to FIGS. 1 through 5, where similar reference characters denote corresponding features consistently throughout the figures, there are shown at least one embodiment. Any implementation of enterprise packaged application (e.g. enterprise application package, enterprise application platform or the like) goes through various stages such as Discovery and Design (Stage 1), Configuration and Coding (Stage 2), and Testing and Change Management (Stage 3). The distribution of effort varies in each stage with a range of ~45% for Stage 1, ~40% for Stage 2 and ~15% for Stage 3. The typical challenges in Stage 1 are translation of business requirements to Design documents—time consuming and incomplete leading to high volume of rework. Cost of wrong requirement can be as high as 5× of the implementation cost. Budget overruns for SAP projects caused by wrong requirements or scope misalignment can range from thousands to several million dollars. For instance, British Petroleum's SAP implementation, initially budgeted at $120 million, escalated to $600 million due to missed requirements and human errors. Similarly, for Stage 2, the typical challenges are misalignment to desired functionality and over-customizations due to custom development. Incorrect process design leads to lost sales, order/invoice errors, or supply chain disruptions, case studies show losses from $20 million to $500 million at large enterprises. In a typical SAP transformation project from ECC to S/4 Hana, +15% of total transformation effort goes to ABAP code remediation. For large enterprises, it can take around 6-9 months for cleaning up the legacy code base and modernizing it for the future scalability. Last but not least, typical challenges for the Stage 3 includes incomplete test execution and limited focus on Change Management initiatives for better adoption leading to ~40% higher failures with User Acceptance Testing. Most importantly, a combination of all of these leads to ~30% less value realization post implementation for the business. From an implementation standpoint it is directly linked to knowledge of the consultant and the team size that varies dynamically with the associates working in the project and the size of the enterprise.

FIG. 1 is a block diagram of an electronic device (100) including a product development lifecycle process automation controller (e.g., SaaS agnostic platform or the like) (140), that delivers ‘Services as Software’ across all products, according to embodiments as disclosed herein. The examples of automation includes, but does not limit to, Creating functionality of old code base with their logical explanation, recommendation of the workability of the old code in the new environment, generation of Business Requirements Documents (BRD). Also, use unstructured meeting notes, meeting recordings and handwritten notes to compare with product features on what is standard in ERP and SaaS platforms and create the BRD. Analyzing the BRD and comparing with what is configured to make sure quality of product is of good. Based on fit gap analysis generate code in an autonomous behavior i.e., multi-system integrations, enhancements to standard functionalities, new report creation. It offers GenAI assistant to provide recommendation of configuration and code generation throughout the life-cycle of implementation. Generate synthetic test data for implementation use-cases. The unique value proposition is based on the following mechanism: 1) The AI Models is trained on SaaS product specific knowledge base (e.g. SAP best practices of system and process setup or the like), 2) Client centric knowledge base (e.g. Coding best practices, Process flows or the like), 3) Practitioner's knowledge base (e.g. real-life case examples of building business use-cases using SAP), 4) Iterative learning based on usage of the product and inputs provided by the users. The combined knowledge base builds over time through dynamic RAG (Retrieval-Augmented-Generation) and offers contextual recommendations to the client during the development cycle.

Further, the electronic device (100) can be, for example, but not limited to a portable computer, a computing device, a laptop, a smart phone, a desktop computer, a notebook, a Device-to-Device (D2D) device, a vehicle to everything (V2X) device, a foldable phone, a smart TV, a tablet, an immersive device, and an internet of things (IoT) device, a server, etc.,

The electronic device (100) includes a processor (110), a communicator (120), a memory (130), a product development lifecycle process automation controller (140), a database (150) and a display (160). The processor (110) is coupled with the communicator (120), the memory (130), the product development lifecycle process automation controller (140), the database (150) and the display (160).

The product development lifecycle process automation controller (140) acts as a versatile co-pilot that streamlines and automates various Software Development Life Cycle (SDLC) steps. By integrating seamlessly into any SaaS environment, it enhances project efficiency by automating key tasks like Business Requirement Document (BRD) creation, user story formulation, and process flow diagram generation. It also standardizes meeting minutes, making them more consistent and actionable. The platform's AI-powered chat-based Q&A assistant improves communication by offering instant, context-aware answers to queries related to the project. Additionally, it automates configuration processes, generates code, and simulates tests, allowing developers to focus more on innovation and less on routine tasks. By doing so, the platform is designed to reduce the cycle time of implementation, migration and support of enterprise applications by approximately 50-60% (for example), leading to faster time-to-market of the business, faster value realization on technology investments, eliminating the knowledge/skill arbitrage in traditional IT services ecosystem, and more efficient resource utilization.

For example, a development project on enterprise packaged software (such as ERP, CRM or CPM) is spread across various stages of execution. It starts with discovery of client's existing business and IT landscape, the processes of various business functions, and understanding of wish-list for future innovation. Such details are gathered over workshops with the senior business leaders of the client's organization. The typical activity, post such workshops is to document the requirements and map it to the technology solution. This activity takes a long time for the business analysts and functional users to create design documentation. Typical challenges are missed requirement, incomplete documentation, misalignment against industry best practices that causes rework and faulty implementation. Fixing such faults in the worst case can cost up to 5× of ones project cost. In a project, the design activity takes around 25% of the total implementation cycle. Once the design is created, the team of developers start system setup activities and custom code development. This takes close to 35% of the overall project lifecycle. Typical challenges are writing bug-free code efficiently. The imagine a project where a team is tasked with developing a new CRM system. Using the product development lifecycle process automation controller, the team can automatically generate the BRD during the requirement gathering sessions with unstructured meeting notes, client interviews, audio and video inputs, and old code-base, ensuring all business requirements are captured accurately. This, otherwise, would have taken several weeks of manual activity to capture all the details and risk of missing out on elements of requirements from various sources. The platform (e.g., Humanize platform or the like) is an AI-driven, multi-agent system designed to automate the full lifecycle of enterprise application implementations across SAP, Salesforce, and ServiceNow. It ingests workshop recordings, transcripts, handwritten notes, whiteboard images, and unstructured documentation, transforming them into structured requirements and detailed summaries. From these, the platform automatically generates process flows, business process diagrams, and comprehensive design documents such as BRDs, FRDs, BPDs, and any additional templates an organization may require. For SAP, the system also creates a business process master list mapped to module-specific questionnaires, forming a foundation for Fit-to-Standard and Fit-to-Gap workshops. Subsequently, it produces user stories, acceptance criteria, and test cases based on the extracted requirements, ensuring completeness and traceability.

Beyond requirements and design, the platform supports the development phase across SAP, Salesforce, and ServiceNow by generating specifications, analyzing configuration or customization logic, assisting with debugging, reviewing code or scripts, and deriving documentation from existing implementations. Whether the artifacts are SAP WRICEF objects, Salesforce Apex/Flow components, or ServiceNow scripts and configurations, the Developer Agent adapts to each technology's development model. The Decision Agent further streamlines delivery by auto-generating test scripts, change-management materials, and training manuals derived from trainer sessions or demonstration videos. Together, these agents form a cohesive system that automates requirements processing, design authoring, development support, testing, and enablement—substantially reducing manual effort and improving accuracy across enterprise application package (e.g., packaged business application, integrated enterprise application system, enterprise application platform, business process application suite or the like).

The platform also helps create user stories and process flow diagrams based on the BRD, ensuring alignment between business and development teams. During sprint planning meetings, the platform standardizes meeting minutes and tracks action items. As the project progresses, the platform's Generative AI assistant provides real-time answers to questions related to configuration and code generation for the implementation. Finally, the platform runs test simulations to identify potential issues early in the process, enabling the team to reduce development time by 50% (for example) and deliver the project ahead of schedule.

Further, the future state vision is to build an AI-powered “Services as software” offerings that integrates enterprise SaaS stack across Customer relationship management (CRM), business process management (BPM), Enterprise Resource Planning for Business Operations (ERP) with an AI engine. The “Services as a software” is a tech-led IT services business model that uses deep-tech to package software services and eliminates talent/cost arbitrage. This model minimizes human dependency, maximize efficiency, focuses on outcome by leveraging orchestration human-acumen and technology-precision. The platform incorporates a responsible AI framework that supports enterprise automation with safeguards for fairness, transparency, privacy, and operational reliability. Guardrails are applied to detect and suppress profanity, toxicity, and contextual misalignment, and generated outputs are validated for client specific relevance, with self-healing reflection agents correcting inconsistencies in produced code. Full traceability and observability of agent behavior is enabled through Langfuse and LangSmith, and RAG grounding ensures responses are linked to trusted domain data to reduce hallucinations and improve explainability. The system avoids the collection or processing of personal or sensitive information and follows privacy by design principles using isolated and containerized deployments. Human oversight remains embedded through review checkpoints for documents and code, while reflection and consistency agents provide autonomous safeguards against unintended results. Reliability is reinforced with automated unit and integration testing through PyTest and GitHub Actions, and dockerised CI and CD pipelines ensure consistent execution across environments. The overall outcome is a transparent, traceable, and ethically governed AI foundation suitable for enterprise trust.

The AI platform leverages various models of Artificial intelligence, LLMs to create AI agents or Agentic AI models to provide IT services as the enterprise application package.

The AI platform begins by ingesting a range of conversations, legacy system code base, client interactions, design documentation, product variants, system configurations, system/user requirements as inputs to the model. The AI model summarizes the information and create a Small-Language-Model (SLM) using principles of Knowledge Repository. In other words, the AI platform starts by ingesting a wide array of inputs, including conversations, legacy system codebases, client interactions, design documentation, and product variants. These diverse data sources are fed into the AI model, which then processes and summarizes the information to extract key insights. Using the principles of a Knowledge Repository, the AI creates a Small-Language-Model (SLM) that effectively organizes and structures the information for easy access and future reference. This SLM serves as a dynamic, continuously evolving repository of knowledge, enabling the platform to provide contextual, accurate responses and insights to users, ensuring streamlined decision-making and improved operational efficiency.

Further, the AI platform then cluster these datasets to arrive at design parameters needed for SaaS implementations.

The AI platform train at least one SLMs with SaaS specific configurations to develop a recommendation engine for system configurations. Further, the AI platform creates a conversational engine that works as a co-pilot to develop SaaS specific custom code development. The specialization is to eliminate dependency on external Large Language Models (LLMs), yet produce contextualized accurate system configuration and coding details. This helps the platform to create specialized agents using smaller language models with high contextualization to get better results thus optimizing the infrastructure cost but still provide privacy and confidentiality with customer's data.

The typical SDLC steps include but are not limited to are as follows.
1. Process scoping
2. Assessment
3. Requirement Gathering
4. Creating Business Requirement Documents (BRD)
5. Fit to SaaS Configurations
6. Creating Configuration Documents like Key Data Structures (KDS)
7. Identifying gaps between business requirements and standard configurations
8. Detailing customization requirements
9. Configuring the SaaS platform
10. Creating of Functional Specifications
11. Creating of Technical Specifications
12. Custom Development of
   a. Workflow
   b. Reports
   c. Integration
   d. Conversions
   e. Enhancements
   f. Forms (output)
13. Creating Training Manuals
14. Conducting training
15. Creating Test scripts
16. Performing Unit Testing
17. Performing Systems Integration Testing
18. Performing User Acceptance Testing
19. Conversions of Data (Master and Transactions)-Data migration
20. Cutover
21. Go-Live

For example, in a typical SaaS project, the SDLC steps may unfold as follows: first, the team works on process scoping to define the project's objectives. They then move to assessment to understand the feasibility of the project. Requirement gathering follows, where business needs are outlined, and a Business Requirement Document (BRD) is created. Once the SaaS platform is chosen, the team focuses on fit-to-SaaS configurations and creates configuration documents like Key Data Structures (KDS). In another embodiment, the platform is chosen first, then the SLDC starts. If there are gaps between the business needs and standard configurations, they identify customization requirements and proceed with configuring the SaaS platform. Subsequently, the team writes functional and technical specifications, followed by custom development for workflows, reports, integrations, and more. Afterward, training manuals are created, and the team conducts training sessions for end-users. The project proceeds with creating test scripts, performing unit testing, system integration testing, and user acceptance testing. The final steps involve data conversion for migration, the cutover process, and finally, the Go-Live phase where the system is deployed and fully operational.

Further, the platform will use various Generative Artificial Intelligence tools not limiting to high level language, Large Language Model and Agentic AI models (Swarm architecture) that works in close orchestration autonomously to reduce the timeline in a SDLC models for SaaS products like SAP, ServiceNow and Salesforce Development Cloud. The platform will leverage existing SaaS providers toolsets, and human intelligence to expedite and improve the quality of the solutions.

The AI agents work in unison with SaaS platform's offered tools, and domain specific documents/datasets that enrich the intelligence and quality of the automation. A list of services that can be served as the enterprise application package AI agents are given below:
1. Scan and read existing business process documents, Standard operating procedures, etc.
For example, in the initial phase of a project, a team tasked with improving the inventory management system begins by scanning and reading existing business process documents and standard operating procedures (SOPs) related to inventory control. These documents include step-by-step instructions on how inventory is tracked, stored, and updated within the current system. The team reviews the current process documentation to understand the workflow, identify pain points, and spot areas of inefficiency. For instance, the SOPs might describe how inventory data is manually entered into spreadsheets or the procedure for stock reconciliation, which could highlight the need for automation. By thoroughly examining these documents, the team gathers valuable insights that will guide the redesign of the inventory management process, ensuring alignment with best practices and the organization's specific requirements.
2. Record and transcribe notes from workshops conducted by SaaS consultants OR translate the written notes (images) to a formal document. The electronic device (100) employs multi-layered guardrails across both pre-and post-LLM stages to ensure responsible, safe, and ethical AI usage. Inputs are validated against the configured client context to prevent cross-tenant data exposure and enforce strict confidentiality. The electronic device (100) performs topic relevance, profanity, and PII checks using OpenAI's omni-moderation-latest model-selected for its strong accuracy and multimodal capability to detect harmful or policy-violating content in both text and audio. Amazon Transcribe's PII redaction further safeguards meeting transcripts, while custom guardrails verify client-specific context alignment and domain relevance to prevent off-topic or misleading outputs. Langfuse observability continuously tracks prompts, responses, and usage patterns for auditability and ethical-AI monitoring. Bias and fairness are tested via controlled prompts, and GDPR-aligned privacy measures (anonymization, encryption, access control) are enforced. Explainability through detailed prompt traceability and response logging ensures every model decision remains transparent, reviewable, and accountable throughout the solution lifecycle.
The electronic device (100) incorporates an extensible tool layer that allows agents to invoke specialized capabilities through MCP based interfaces and direct integrations. One of the MCP driven tools verifies OEM specific code elements, for example checking whether SAP CDS views are publicly released and listed in the SAP Business Hub before they are referenced in generated specifications or implementations. Additional tools support web based information retrieval, the OCR extraction from handwritten notes, audio to text conversion for meeting or field recordings, and execution within an E2B sandbox to interpret, analyze, and test code in an isolated environment. These tools can be invoked autonomously by agents based on task requirements, and the orchestration layer manages permissions, context passing, and result validation. This approach provides grounded output, reduces manual verification, and enables automated reasoning that is aligned with real system constraints and external data sources.
In an example, after conducting a series of workshops with SaaS consultants to discuss the customization of a new CRM system, the project team gathers all the handwritten notes and images taken during the sessions. The next step involves recording and transcribing these notes into a formal document. For instance, during the workshops, consultants have drawn flowcharts, highlighted key requirements, and outlined critical timelines on whiteboards and flipcharts. These notes are transcribed into a digital format, with the hand-drawn diagrams recreated and annotated for clarity. The transcriptions are then compiled into a formal report that summarizes the discussions, including detailed specifications for system configurations, proposed integrations, and any customization needed for the CRM system to meet the company's unique needs. This formal document will serve as an official reference for the development and implementation teams as they proceed with the project.
3. Read recorded materials/images of hand-written notes to capture the business requirements.
For example, the project team is tasked with implementing a new employee onboarding platform. During a series of brainstorming sessions, key stakeholders and HR managers took handwritten notes on flipcharts and whiteboards, outlining critical business requirements such as user authentication, integration with payroll systems, and tracking employee progress through onboarding steps. After the sessions, the team reads the recorded materials and images of these hand-written notes to capture the business requirements. For example, one image might show a flowchart depicting the onboarding process, while another includes a list of features requested by HR, such as automated email notifications and customizable checklists. The team transcribes and organizes these details into a formal document, which becomes the foundation for creating the Business Requirements Document (BRD), ensuring that all stakeholder needs are clearly defined and ready for the next phase of the project.
4. Business requirements relevant to the customer and the corresponding SaaS platform will be generated.
In an example, a retail company wants to implement a new SaaS-based inventory management system. The project team collaborates with key stakeholders from the company's supply chain and warehouse departments to gather business requirements relevant to the customer. These requirements include features like real-time stock tracking, automated restocking alerts, and integration with existing e-commerce platforms for seamless inventory updates. Once these business needs are clearly defined, the team maps them to the corresponding SaaS platform. For example, they determine that the SaaS platform's built-in integration with e-commerce systems will address the customer's need for automatic inventory updates. Similarly, the platform's real-time analytics dashboard meets the requirement for tracking stock levels and generating alerts. This process ensures that the SaaS platform is configured to meet the specific needs of the retail company, improving efficiency and reducing manual inventory management tasks.
5. While a humanAIze platform (for example) is using LLMs to generate code, there has to be a mechanism to automate the review of that LLM generated code as well. So it's kind of self-reflection agent. While one of the agents is responsible for generating code, the other agent works as a critique and review that code in a sandbox before delivering to human. We also need to make the LLM calls more contextualized to ensure better responses. One popular way is to use RAG (retrieval augmented generation). By adding contexts while calling LLMs, ensure that model has access to relevant background information, reducing hallucinations and improving response accuracy. This approach helps tailor the output to specific queries by grounding the generation in factual and contextual data. Since each time LLM may provide different response against the same question, we also have added self-consistency mechanism that ensure almost similar response is being returned against the same question. The electronic device (100) incorporates self-reflection as an internal evaluation process in which an agent reviews its own intermediate output, checks it against contextual requirements, expected structural patterns, and domain constraints, and then regenerates an improved version without relying on an external reviewer. This mechanism allows the agent to detect gaps, contradictions, missing steps, or incorrect assumptions before presenting a final result. Alongside this, the system applies self-consistency, where multiple reasoning paths are generated for the same instruction and the responses are compared to identify the most stable and convergent outcome. By selecting the result with the highest alignment across reasoning samples, the system increases reliability when processing complex, multi-layer, or ambiguous tasks. Together, these methods reduce variability, enhance accuracy, and provide a more dependable reasoning process that improves over repeated executions.
6. The humanAIze platform also takes into consideration old code-base and generates functionality explanations in the form of design documents that makes it easier for deciphering complex code and interpreting the new code-base for faster implementation.
7. Assist human in the loop to generate content of the requirements document in a chat interface and help assemble to content to generate the BRD.
In an example, an enterprise application package development team is working with a client to implement a custom SaaS platform. To generate the Business Requirements Document (BRD), the team uses a chat interface integrated with an AI assistant that assists in gathering and organizing content. The AI prompts the project manager with questions like, “What are the key features required for the user interface?” or “Do you need integration with any third-party tools?” As the project manager answers these questions, the AI system collects the responses, generates relevant content, and suggests structured sections for the BRD, such as functional requirements, user stories, and technical specifications. For instance, when the project manager responds that the platform needs an integration with a CRM system, the AI suggests a section under “System Integrations” and automatically generates a draft describing the integration flow. The AI also assists in rephrasing and organizing input from other stakeholders into clear, concise requirements. As the human user interacts with the system, the AI gathers all the necessary content, ensures it aligns with the client's needs, and assembles it into a cohesive BRD, ready for final review and approval. This collaborative process significantly reduces the time spent manually drafting the document while ensuring accuracy and completeness.
8. Compare with SaaS standard configuration guide like Digital Discovery Assessment from SaaS products. For example Digital Assessment from SAP can be compared with the BPML (Business process mapping list) that we will generate from our BRD. The flow is as follows. Meetings Notes ->BRD->BPML's=>compare with DDA or configuration list, generate gaps and so on.
9. Create a sequence and predecessor configurations must have's.
In an example, in the context of implementing a new SaaS-based customer relationship management (CRM) system for a client, the project team needs to create a sequence of configurations and establish predecessor configurations that must be in place before others can be executed. The team starts by defining the sequence of configurations in the CRM system: first, they must configure user roles and permissions to define who can access what data. Once roles are established, the next step is to configure the customer database structure, including customer fields and relationships. The team also identifies the predecessor configurations: for instance, before setting up automated workflows or email templates, the CRM system's basic configuration, such as user roles, data fields, and integrations with external systems, must be completed. Similarly, setting up reporting features can only be done after the database structure is finalized, as reports depend on the data model. By defining this sequence and the required predecessor configurations, the project team ensures that all configurations are made in the correct order, avoiding errors and delays during implementation.
10. To be configure the SaaS product using their tools like SaaS implementation workbench and or API's generated by the proposed platform.
11. Generate Fit-to-Gap's list.
In an example, a company is adopting a new SaaS-based enterprise resource planning (ERP) system, and the project team needs to generate a Fit-to-Gap list to identify how the new system aligns with the company's existing processes. The team starts by reviewing the business requirements and current workflows, comparing them against the functionalities provided by the ERP platform. For example, the team identifies that the ERP system has a built-in inventory management module, which matches the company's current process for tracking stock levels-this is considered a “fit.” However, the company requires a specific feature for custom packaging options during the order fulfillment process, which is not available in the standard ERP system. This gap is noted as a “gap” in the Fit-to-Gap list. The team then categorizes these gaps as either requiring customization (e.g., developing a custom feature to handle packaging) or process adjustments (e.g., modifying the order fulfillment process to work with the available features). The final Fit-to-Gap list will include both the “fits” (where the system meets the requirements) and the “gaps” (where the system needs to be customized or adjusted), enabling the project team to prioritize actions for configuration, customization, or process redesign.
12. Generate base code using low code/no code methodology for
   a. Bank Integrations (e.g. payment advice, payment acknowledgment, etc. ,). We are building a product that will be deployed as a package for customers to set up the bare minimum to integrate with banks
   b. Third party system integrations such as Tax integrations, Gate Pass applications, Weighbridge integration, integration with IOT/Sensor based systems in the factories are multiple standard cases integrations that requires multiple days of development effort. The code generation functionality can reduce it to a significant extent.
13. Create forms template by scanning existing formats of the customer like
   a. Purchase Order,
   b. Customer Invoice, and
   c. Check printing
14. Generate tasks, plan, effort from BRD and assign to users via Jira (for example).
15. Generate test cases from BRD.
In other words, after reviewing the Business Requirements Document (BRD) for a new e-commerce website, the testing team generates test cases to validate the platform's functionalities. For example, one of the requirements in the BRD specifies that users should be able to apply discount codes during checkout. From this, the team creates a test case that includes steps such as logging in, adding items to the cart, entering a valid discount code at checkout, and confirming that the total price reflects the discount. The expected result is that the correct discount is applied and the order total updates accordingly. By generating such test cases, the team ensures that all business requirements are properly tested and the system functions as expected before going live.
16. Execute automated testing where possible like Unit Testing.
17. Creating Training Manuals from the above steps.
18. Assist in converting/migrating/moving data from legacy application to new platform.
19. Make sure that all unique business requirements are tested either as part of process testing and or end to end business process testing.
20. The platform (or electronic device) is built on a modular, cloud-native web architecture designed to support secure, large-scale, multi-tenant enterprise implementations. The electronic device follows a decoupled model in which the client-facing web layer, backend application services, and AI processing layer operate independently but interact through well-defined APIs and event-driven workflows. The web tier provides authenticated access for consultants and project teams, enforcing tenant-level isolation and granular role-based permissions. It acts primarily as an orchestration and presentation layer, delegating all computation-intensive tasks—such as requirements analysis, design generation, agentic workflows, and AI reasoning—to dedicated backend and AI microservices. This structure ensures that the UI remains responsive, even when users initiate long-running operations such as summarizing multi-hour workshop recordings or generating complex design documents.
21. At the backend lies a collection of domain-specific microservices that handle project management, document handling, vector indexing, metadata capture, workflow orchestration, audit logging, and integration with enterprise systems such as SAP, Salesforce, and ServiceNow. These services communicate over REST and asynchronous queues, enabling horizontal scaling and fault tolerance. The architecture incorporates object storage for large files, vector databases for embedding-based retrieval, relational and NoSQL stores for structured data, and secure secrets management for credentials, encryption keys, and tenant-specific configuration. Long-running AI tasks are offloaded to a scalable agentic layer that uses event triggers, background workers, and managed compute to process requests in parallel without blocking user interactions.
22. Surrounding this core is a set of security and governance controls, including network isolation, encryption at rest and in transit, preassigned URL-based file movement, audit trails, and per-tenant sandboxing to ensure data segregation. The architecture is cloud-agnostic yet optimized for deployments on AWS, Azure, or GCP, leveraging services such as container orchestrators, serverless compute, message queues, and managed database offerings. This approach enables both vertical and horizontal scaling, supports burst workloads during heavy document or AI processing, and ensures high availability across customer environments. Overall, the Humanize web architecture provides a robust, extensible foundation that supports the platform's agentic capabilities, delivering secure, scalable, and efficient automation across the entire enterprise application package lifecycle.

The product development lifecycle process automation controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an example embodiment, the communicator (120) can include an electronic circuit specific to a standard that enables wired or wireless communication. In an example embodiment herein, the communicator (120) may include, for example, at least one of an Internet, a wired medium (e.g., a Local Area Network (LAN), a Controller Area Network (CAN) network, a Universal Asynchronous Receiver/Transmitter (UART), a bus network, Ethernet and so on), a wireless medium (a Wi-Fi network, a cellular network, a Wi-Fi Hotspot, Bluetooth, Zigbee and so on using Wireless Application Protocol), a direct interconnection, and so on.

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 1 shows various hardware components of the electronic device (100) but it is to be understood that other embodiments are not limited thereon. In other embodiments, the electronic device (100) may include less or more number of components. Further, the labels or names of the components are used only for illustrative purpose and does not limit the scope of the invention. One or more components can be combined together to perform same or substantially similar function in the electronic device (100).

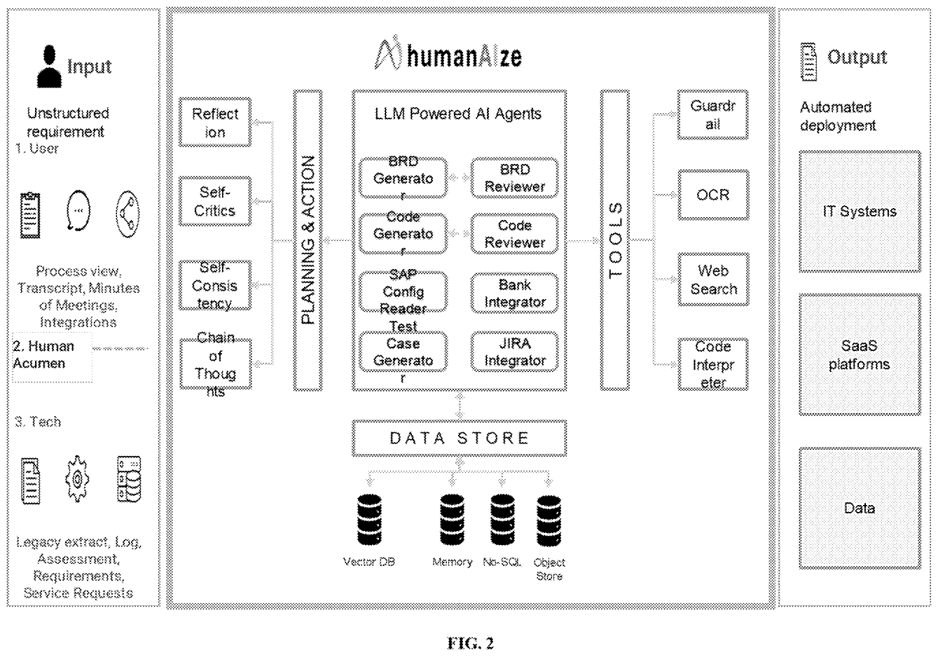

FIG. 2 is an example scenario in which operations of the product development lifecycle process automation controller (140) is explained, according to embodiments as disclosed herein. The various operations of the product development lifecycle process automation controller (140) is explained in FIG. 1. For the sake of brevity, we are not repeating the same operations in the patent disclosure.

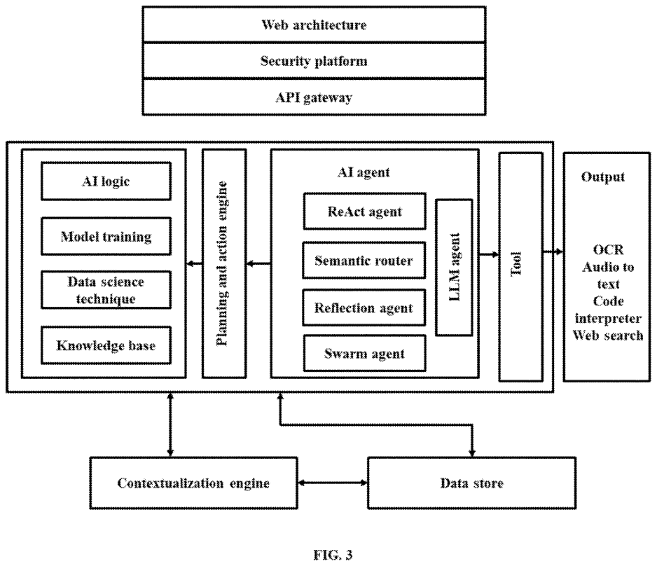

FIG. 3 is an example illustration in which an orchestrating multi-agent workflows with reasoning, retrieval, guardrails, and tool integration, according to embodiments as disclosed herein.

There are three types of inputs coming into the platform such as structured inputs in the form of due-diligence assessment reports, application health scan reports, and process assessment reports, semi-structured inputs such as existing code-base, library files, application configuration details, and unstructured inputs in the form of business workshop discussions in natural language

Further, the platform and various modules are trained on knowledge base of Original Equipment Manufacturer (OEM) best practices, over a million lines of code, industry best practices, and practitioners knowledge base that acts as a foundation to the training inputs to the AI techniques built into the platform

The platform includes at least three AI agents such as discovery agent, developer agent and a decision agent.

In an example, by using the discovery agent, the platform accepts all the inputs and validates against a trained knowledge base and produces industry aligned design assets in the form of business requirement document, business process documentation, business process master list that are key for SAP implementation. A Unique Selling Proposition (USP) of the auto-generated design functionality is not only to create the design artifacts at the click of a button, but also aligning it to the best practices of the industry, and making sure quality output is assured.

In an example, by using the developer agent, the design assets act as in input to the AI models, which auto-generating code base for custom development. The code generation technique mimics the life of the developer by generating the code, compiling it, resolving issues and producing a tested code as per the best practices recommended by the OEM (a general purpose LLM doesn't produce code that is worthy for deployment). The platform has self-reflection and self-consistency technique written which helps in eliminating hallucinations and produce accurate code every time. The code-generation functionality also helps in auto-remediation of legacy code-base and migrates legacy custom objects to cloud-native code-base for modernization. The developer agent also provides copilot assistance in the form of conversational AI and helps a developer configure the system with guided steps.

In an example, the decision agent takes input from the discovery and developer agents and creates the test cases and synthetic test data that expedites the testing cycle

The platform adopts modular service architecture with contextual, secure agent intelligence. This enables orchestrating multi-agent workflows with reasoning, retrieval, guardrails, and tool integration.

The platform exposes its AI capabilities through RESTful, composable APIs that allow seamless plug-and-play integration into enterprise ecosystems. A uniform API layer is built using REST-based microservices that encapsulate all AI functions such as discovery, build, test, and assurance, so as to ensure consistent access patterns across all modules. The APIs are designed to be stateless and idempotent, using an Idempotency-Key header to guarantee safe retries without duplicating actions. For example, if a client calls the /generate/user-story endpoint twice with the same Idempotency-Key, only one BRD/BPML story will be created, preventing redundant outputs.

The endpoints are composable, enabling enterprises to automatically generate BRD/BPML user stories, perform OEM-aligned deployable code generation, migration, and review, as well as produce test cases, coverage reports, and guardrails through unified API calls.

Security and governance are enforced through a multi-layered architecture incorporating OAuth2/JWT-based authentication, role-based access control, and tenant-level isolation to ensure strict separation of customer data. All communication between the web layer, backend microservices, and AI processing components is encrypted using TLS, while data at rest-whether in object storage, databases, or vector indexes—is protected through server-side and customer-specific encryption keys managed via cloud-based secrets managers. Pre-signed URLs are employed for controlled file transfers, ensuring time-bound, least-privilege access to large documents and media artifacts. Access to configuration parameters, credentials, and encryption keys is restricted through fine-grained IAM policies, credential rotation, and zero-trust controls. Every user action, system event, and AI task invocation is captured in immutable audit logs to comply with enterprise governance, traceability, and regulatory requirements. Together, these security measures provide comprehensive protection across identity, data, network, and operational layers of the Humanize platform.

The system includes full observability through serverless auto-scaling, per-call metering, and structured logs visualized in monitoring dashboards. For instance, when multiple users trigger the/code/review endpoint simultaneously, adaptive throttling automatically regulates throughput to ensure fair usage and stable performance under high load.

In an embodiment, the platform comprises a multimodal knowledge fabric configured to ingest and process heterogeneous data inputs including structured, semi-structured, and unstructured content such as configuration files, source code, and conversational transcripts. The platform constructs domain-specific knowledge bases that are dynamically aligned to OEM or enterprise best practices. To ensure cost-efficient and deterministic reasoning, the platform employs a collection of Small Language Models (SLMs), each specialized per SaaS platform (for example, Salesforce™, ServiceNow™, or SAP™) to provide platform-specific intelligence and reduce inference overhead compared to larger, generalized models.

The platform further includes an agentic orchestration layer comprising a plurality of intelligent agents operating in coordination to perform end-to-end lifecycle automation. The discovery agent validates the input data and auto-generates design assets such as architecture diagrams, data models, and configuration templates, ensuring compliance with industry or the OEM standards. The developer agent simulates the complete enterprise application package development lifecycle through iterative operations including code generation, compilation, testing, self-healing, and convergence to a validated build. The decision agent autonomously generates test suites, produces synthetic test data, and performs readiness or quality assessments based on the system's knowledge base and defined KPIs.

To ensure robust reasoning and reliability, the platform employs Retrieval-Augmented Generation (RAG) as the primary grounding mechanism, thereby preventing hallucinations and ensuring factual consistency. Reflection and self-consistency loops are executed after each agentic task to detect and minimize logical or syntactic errors, ensuring that only deployable artifacts are produced. Prompt injection mitigation is achieved by isolating user prompts from system instructions, implementing schema validation and intent filtering prior to model invocation. Additional safety rails include profanity and Personally Identifiable Information (PII) filtering, controlled sandbox execution environments, and explainability through LangSmith-grade traceability logs, which record reasoning paths, model outputs, and decisions for audit and debugging.

The platform operates within a cloud-native, event-driven, serverless architecture, utilizing services such as AWS Lambda™ and EventBridge™ for dynamic scalability. It supports adaptive rate limiting, per-API cost metering, and multi-tenant governance controls, enabling efficient workload distribution and cost transparency across users and environments.

In an example implementation, an enterprise user uploads a set of Salesforce™ configuration files and associated customer service transcripts. The multimodal knowledge fabric ingests the inputs and constructs a Salesforce-specific knowledge graph. The discovery agent validates the configurations and generates a compliant design specification. The developer agent subsequently produces Apex™ code aligned with OEM conventions, compiles and tests it in a sandbox, and self-corrects any detected issues through feedback loops. The decision agent then generates synthetic test cases for regression validation. Throughout this process, RAG-based grounding ensures that generated artifacts adhere to enterprise policies, while safety mechanisms filter out any sensitive or non-compliant content. All transactions are logged in a secure audit trail, and the system scales automatically to handle concurrent processing requests from multiple teams.

In an embodiment, the proposed platform introduces a set of differentiating features that collectively establish the novel and scalable AI-driven automation framework purpose-built for enterprise SaaS ecosystems. The proposed platform implements a Language Model (LM)-first strategy, wherein each AI model is trained and optimized for a specific SaaS domain or OEM platform. This specialization substantially reduces computational cost, enhances deterministic behavior, and ensures strict adherence to OEM-specific design and deployment standards.

The proposed platform employs developer mimicry through reflection-driven “compile and self-heal” feedback loops that emulate a human developer's lifecycle. Rather than merely generating raw code, the proposed platform compiles, validates, and autonomously rectifies defects to produce deployable, production-ready artifacts. This self-healing behavior enables continuous convergence toward executable and compliant solutions, significantly reducing the manual intervention typically required in code refinement or migration processes.

To ensure audit-ready explainability, every AI action and decision point within the proposed platform is transparently logged, traceable, and contextually grounded to its originating source, be it a configuration file, transcript, or code snippet. This enables comprehensive lineage tracking and facilitates compliance with enterprise audit and governance standards.

The proposed platform embodies a robust enterprise security posture by enforcing zero-trust principles for file handling, utilizing short-lived access tokens, and maintaining immutable audit trails for all operations. This ensures that data privacy, integrity, and compliance requirements are upheld throughout the model's lifecycle.

Designed for operational pragmatism, the proposed platform adopts a cloud-native elastic architecture that supports dynamic scaling, cost metering, and fine-grained governance controls. Unlike conventional consulting-driven models, the system scales like SaaS software, maintaining predictable cost efficiency and performance at enterprise scale.

Further, the proposed platform provides end-to-end lifecycle coverage, encompassing migration, greenfield deployment, and upgrade workflows within a single unified AI framework. By codifying domain expertise into modular, reusable components, the proposed platform enables a Services-as-Software (SaaS) model, wherein specialized professional services are transformed into consumable, software-delivered capabilities that scale independently of linear human headcount.

In an example implementation, a large enterprise initiates a ServiceNow™ migration using the system. The LM-first architecture deploys a ServiceNow-specialized language model that interprets legacy configurations and maps them to new platform standards. During the process, the developer mimicry loop generates migration scripts, compiles them in a sandbox, detects and self-heals misconfigurations, and produces validated deployable packages. Each transformation step is logged with full traceability, linking generated artifacts to their original source data and AI reasoning trail. The process runs within a zero-trust execution environment using ephemeral credentials and produces an immutable audit report for compliance. The system automatically scales during high-load phases and contracts after completion, ensuring optimal cost utilization illustrating its unique combination of technical precision, operational elasticity, and audit-ready transparency.

Existing web applications often face challenges in scalability, secure handling of documents, and multi-session management. Many architectures rely on synchronous APIs for heavy file payloads, leading to performance bottlenecks, higher costs, and increased attack surfaces. Furthermore, user authentication models often compromise between usability and security, without offering fine-grained session isolation.

In the proposed platform, a web architecture discloses a multi-layered architecture that combines event-driven serverless computing, secure document handling, adaptive access control, and real-time monitoring. The proposed platform ensures elastic scalability while maintaining strict security and compliance guarantees. The proposed platform has a context-aware multi-tab session isolation feature, a hybrid login enforcement feature, a dynamic cost tracking feature, and a malware-aware file quarantine feature.

In an embodiment, the proposed platform implements the context-aware multi-tab session isolation feature, the hybrid login enforcement feature, the dynamic cost tracking feature, and the malware-aware file quarantine feature to ensure secure, efficient, and compliant operation across multi-tenant enterprise environments. The context-aware multi-tab session isolation feature (or mechanism) detects and differentiates user sessions opened across multiple browser tabs or devices, maintaining independent security and state contexts for each. This prevents cross-tab data leakage or command interference, thereby preserving the integrity of concurrent workflows.

In details, the proposed platform further employs the hybrid login enforcement feature, combining single sign-on (SSO) with multi-factor authentication (MFA) policies based on session context, sensitivity of the operation, and user role. For instance, a high-privilege user performing a deployment operation may be required to re-authenticate using MFA, even if authenticated via SSO earlier in the session.

The dynamic cost tracking feature is embedded at the API and operation level, where each invocation is metered in real-time based on compute utilization, data processed, and model inference duration. This enables granular billing visibility and facilitates adaptive throttling or budgeting for individual teams or projects.

The malware-aware file quarantine subsystem inspects all uploaded files using heuristic and AI-based scanning models prior to ingestion. Files exhibiting anomalous patterns such as obfuscated scripts, encrypted payloads, or unrecognized metadata, are automatically redirected into a quarantine state, isolated from production workflows until verified or remediated by a trusted process.

In an example implementation, a system administrator logs into the platform using SSO credentials to manage an ongoing migration project. The platform detects that two browser tabs are active for the same user, one performing code review and another generating test cases, and automatically isolating the session states to prevent data crossover between tabs. When the user attempts to initiate a production deployment from one tab, the hybrid login enforcement feature triggers an additional MFA verification due to the elevated operation sensitivity. During the same session, the system's dynamic cost tracker records API usage and model inference time, updating the real-time cost dashboard for the project. Meanwhile, a developer uploads a ZIP file containing automation scripts, the malware-aware file quarantine mechanism identifies embedded macros with suspicious entropy and holds the file in a secure quarantine container until reviewed. This example demonstrates the platform's intelligent, adaptive security and cost-governance capabilities that enhance operational resilience and compliance in enterprise-grade deployments.

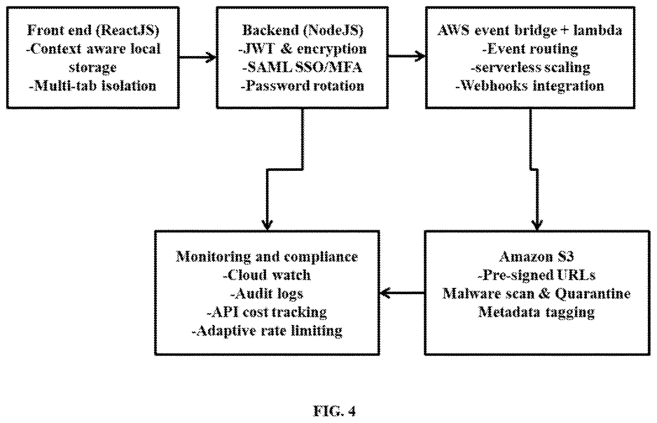

FIG. 4 illustrates an architectural overview of the platform, according to embodiments as disclosed herein. The architectural overview includes a frontend and context management engine, a backend and event-driven engine, a document management engine, a security framework engine, and a monitoring and compliance engine.

The frontend and context management engine is implemented in ReactJS, wherein each browser tab operates with local storage scoped per project context. This configuration enables a single user to manage multiple concurrent projects in isolated browser tabs without cross-context interference. The engine enforces a single active login policy by restricting simultaneous logins from multiple devices or browsers, thereby maintaining a balance between usability and account security.

The backend and event-driven engine is architected around a stateless, asynchronous processing model. The backend and event-driven engine integrates with a message-routing service for asynchronous event orchestration and stateless function execution. Webhooks are employed to facilitate external system integrations such as CI/CD pipelines or third-party SaaS connectors without overloading the core application. An event-processing layer operates in a serverless configuration, enabling elastic scaling such that each event type (e.g., code generation, test synthesis, or migration validation or the like) scales independently according to workload demand, optimizing performance and cost utilization.

The document management engine ensures secure handling of all files and records. Documents are uploaded and stored using pre-signed URLs that provide short-lived access tokens, thereby minimizing the exposure window. Files are never embedded or transmitted within API payloads, significantly reducing the risk of inadvertent data leakage. Prior to being made accessible to downstream processes, every file is subjected to AI-assisted malware scanning, and any suspicious artifact is automatically quarantined until verified as safe.

The security framework engine enforces end-to-end encryption of all data transmitted between the frontend and backend layers. Authentication is managed using JWT tokens with defined expiry and rotation policies, ensuring temporal access validity. For enterprise tenants, SAML-based Single Sign-On (SSO) is supported, while non-SSO users are required to authenticate using multi-factor authentication (MFA). The system further mandates strong password enforcement with periodic 90-day rotation cycles, maintaining compliance with enterprise-grade security standards.

The monitoring and compliance engine captures and audits every user and system activity through immutable audit logs, recording metadata such as user identity, timestamp, and action performed for forensic traceability. CloudWatch-based monitoring continuously analyzes operational metrics and generates real-time alerts for anomalies or suspicious activity. Additionally, per-API call cost tracking provides visibility into resource utilization, enabling chargeback accounting, anomaly detection, and prevention of resource misuse.

In an example implementation, the enterprise application package architect logs into the platform through SAML-based SSO to manage two concurrent projects, a Salesforce™ migration and a ServiceNow™ upgrade, across two browser tabs. Each tab maintains an isolated context via scoped local storage, ensuring that project data and session variables do not overlap. When the architect attempts to log in from another device, the platform automatically invalidates the previous session in accordance with the single-login policy. In the backend, a webhook triggers a code generation event routed through the event-driven core, invoking a stateless function that scales automatically based on the workload. The architect uploads a configuration file, which is securely handled via a pre-signed URL and scanned for potential malware before being accepted into the repository. All actions, including authentication events and file uploads, are encrypted end-to-end and recorded in audit logs. CloudWatch detects a spike in API calls during the build process and dynamically scales event processors while updating per-call cost metrics. This example illustrates the platform's seamless integration of usability, elasticity, and compliance within a secure, multi-tenant architecture.

In an embodiment, the proposed platform implements a multi-layered architecture comprising context-aware session isolation, a zero-trust-inspired security layer, adaptive rate limiting and cost control, a secure document processing pipeline, and a scalable audit and compliance framework, collectively enabling secure, scalable, and governance-ready enterprise operations.

The context-aware session isolation mechanism allows a single authenticated user to initiate and operate multiple independent project sessions concurrently within separate browser tabs, each maintaining its own scoped session context and local storage. This design ensures that session data, such as tokens, cache, and active models, remains fully segregated across projects. Concurrently, the proposed platform enforces a strict single-device policy, prohibiting parallel logins across different browsers or devices to prevent credential replay or session hijacking, thus enhancing both security and operational integrity.

The system's zero-trust-inspired security layer ensures that each API request and event invocation, including those originating from internal services, undergoes independent authentication and authorization checks. This approach eliminates implicit trust assumptions, enforcing a security boundary even between intra-platform microservices. For example, a code generation microservice must revalidate its authorization before invoking a test synthesis function, preventing privilege escalation or unauthorized lateral movement.

The adaptive rate limiting and cost control module employs dynamic throttling to regulate API consumption at the granularity of user, project, or organization. The proposed platform monitors real-time usage metrics and dynamically adjusts rate limits when anomalous traffic or cost spikes are detected. For instance, if a sudden surge of model inference requests exceeds the user's typical pattern, the proposed platform automatically throttles or queues the requests, preserving platform stability and preventing budget overrun.

The secure document pipeline establishes an end-to-end mechanism for safe file handling. Files are never embedded in the API payloads but instead are uploaded and accessed using short-lived, pre-signed URLs that automatically expire after a defined period. Upon upload, each file undergoes malware scanning and integrity validation, and is then tagged with contextual metadata such as user identity, project association, and timestamp. This metadata enables traceability, governance, and compliance-ready record keeping across all document-Handling operations.

The scalable audit and compliance framework ensures that all system interactions, ranging from authentication events and data operations to AI-driven code generation, are captured in immutable audit logs. These logs can be securely exported to enterprise compliance systems to meet regulatory obligations such as general data protection regulation (GDPR), Health Insurance Portability and Accountability Act (HIPAA), or Sarbanes-Oxley (SOX). The framework supports structured query interfaces, allowing authorized auditors to perform forensics or verify operational conformance without impacting live workloads.

The platform undergoes continuous Vulnerability Assessment and Penetration Testing (VAPT) across the web interface, backend APIs, and AI agentic processing layer to validate resilience against modern attack vectors, including prompt injection, model manipulation, and jailbreak attempts. These assessments include automated scanning, manual penetration exercises, dependency analysis, and adversarial testing tailored to large language model interactions. The platform also aligns with ISO 27001 controls and has implemented its requirements for asset management, access governance, incident response, data protection, and secure development practices. Certification activities include periodic audits, risk assessments, and evidence-based verification of all security controls. Together, this combination of VAPT and ISO 27001 compliance ensures the platform meets stringent enterprise security standards and remains protected against evolving threats in both traditional and AI-specific domains.

In one example implementation, a product engineer accesses the platform and opens three project sessions, CRM migration, data pipeline optimization, and UI refactoring, in separate browser tabs. Each tab maintains an isolated context, preventing data overlap or token reuse. When the same engineer attempts to log in from a different browser, the proposed platform automatically rejects the session, enforcing the single-device policy. During operation, the engineer's project triggers a sequence of asynchronous API calls for model-assisted code generation and test validation. Each API invocation is independently authenticated through the zero-trust layer. As workload increases, the adaptive rate limiter detects an abnormal request burst from the CRM project and temporarily slows the traffic to maintain budget thresholds. Meanwhile, the engineer uploads a configuration file, which the secure document pipeline scans for malware, tags with user and timestamp metadata, and stores via a short-lived pre-signed URL. All these actions, including authentication checks, API throttling decisions, and file scans, are recorded in immutable logs that can be exported to the enterprise's GDPR compliance console. This example demonstrates how the system ensures secure, context-aware, and cost-efficient operation while maintaining full auditability and regulatory alignment.

Reflection and Consistency Agents: The proposed platform enables autonomous design and code generation and review with iterative self-editing using reflection loops. For a general purpose LLM, there will always be different responses for every iteration, which cannot be afforded in a code generation or system configuration scenario. This functionality removed any potential hallucinations for a straight through LLM call. The platform must be consistent, and consistently accurate. The specialization in the proposed platform is built by mimicking the life of a developer in any implementation cycle, to make the output ‘usable’ for system implementation/migration/enhancement & support.

The swarm architecture has various sub-agents that develop, validates, compiles in sandbox, adopts industry/client specific best practices of coding and generates a code that is deployable. The actions are completely autonomous with limited intervention from human-in-the-loop. The platform includes orchestration layer that coordinates multi agent system, where different specialized agents collaborate to complete complex tasks in a controlled sequence. The orchestration logic supports patterns such as self-reflection, where an agent evaluates and improves its own output, a supervisor model that allocates work and validates outcomes across agents, and a semantic routing mechanism that directs user intent to the appropriate agent based on domain, context, and required capability. The system uses React style agents that maintain state across turns, exchange intermediate reasoning, and trigger tool use when needed, allowing tasks to be decomposed, verified, and recomposed into a final result. This coordinated behavior enables accuracy, reduces error propagation, and provides a scalable structure for expanding agent roles over time.

Contextualization through RAG: The proposed method reorders content chunks based on relevance to prioritize and contextually aligned insights. This is achieved through creating knowledge bases through vectorization. A general purpose LLM will always look at a wider source of knowledge and by doing so it either loses the context or provides too generic an output which is not fit for consumption. This approach, over a period, will reduce dependency on LLMs, optimize the token consumption, and build specialization for industry use-cases. The product uses a Retrieval Augmented Generation approach that relies on multiple vector databases, including AstraDB, Pinecone, and Chroma, each selected based on the nature of the content being indexed, performance requirements, and deployment considerations. Information is divided using a controlled chunking method that maintains semantic continuity while keeping retrieval fast and precise. When a query is processed, the system retrieves candidate chunks from the relevant vector store and then applies a reranking stage that evaluates contextual relevance, proximity to intent, and domain fit before passing the refined results into the generation layer. This design provides consistent grounding of responses, minimizes irrelevant context, and offers reliable retrieval behavior across different types of knowledge used by the platform.

Self-Learning: The proposed platform enhances LLM responses by injecting context tied to an activity. The proposed platform builds knowledge repository through user-actions and gets fine-tuned at every iteration. The system incorporates a continuous self-learning adaptation subsystem that captures, processes, and applies post-generation user feedback and implicit interaction signals to modify subsequent document or code generation behavior. These feedback artifacts are normalized into structured semantic deltas through intent parsing, topic classification, and transformation-pattern extraction. In parallel, the platform records comprehensive audit-trail telemetry for all user operations, including edits, regeneration triggers, rejection events, and contextual constraints applied during the interaction. This operational history persisted within a NO-SQL knowledge state layer and indexed against output variants, domain context, and OEM-specific configuration attributes. A reinforcement logic engine synthesizes explicit feedback and implicit operational signals into an adaptive generation profile, which is automatically injected into future inference prompts, decision policies, and agent-level orchestration sequences.

Knowledge base: Design, Discovery, Recommendation, and Coding is not a mere generation engine, but it complies to industry coding standards, best practices of the OEMs, and practical experience of handling real-life intricacies of project implementation. The models are trained on 1) publicly available information (provided by OEMs), 2) over a million lines of code with variations and boundary conditions, 3) experience of experts in the team having been delivered +20 large scale global rollouts each. As a roadmap, the proposed method are introducing integrations with GitHub communities and similar expert communities in the field of SAP, ServiceNow and Salesforce for real-time update of knowledge base with best practices in such technologies.

Fit-for-Purpose: The proposed platform uses multi-modal architecture using different approaches of Agentic AI that is best suited for the activity:

Swarm Agents: The proposed platform coordinates multiple specialized agents to converge on reliable, consensus-driven outcomes. This is used for complete autonomous functions e.g. design generation and recommendation.

Single-Pass Workflow: The proposed platform executes linear, no-loop agent flows for sequential tasks without inter-agent complexity. This is used where human-in-loop may be required e.g. code generation.

Co-pilot: Where guided assistance is required to accomplish a task e.g. system configurations. The system comprises a plurality of autonomous configuration assistant modules, each instantiated for a distinct enterprise software OEM platform such as SAP, ServiceNow, or Salesforce. Each module is constructed upon a shared orchestration framework but dynamically loads OEM-specific knowledge embeddings, policy constraints, configuration taxonomies, and operational semantics. The system ingests OEM documentation, configuration guides, metadata schemas, and platform reference materials, which are normalized, segmented, and vector-encoded into a proprietary semantic retrieval index. A Retrieval-Augmented Generation (RAG) pipeline enables context-conditioned reasoning, wherein user intents are mapped to OEM configuration artifacts through similarity scoring, ontology alignment, and constraint resolution. The system further incorporates adaptive document refresh logic that invokes custom data acquisition tools to retrieve and reconcile updated OEM resources from authenticated or publicly accessible web endpoints.

Guardrails: The AI output has several checks on profanity, relevance, PII information which prevents (or alerts) a developer to produce output with sensitive content. The proposed method have published Ethical AI best-practices and standards which are followed as practice for any development related to AI.

In an embodiment, the proposed platform provides an integrated use-case coverage framework that addresses the complete enterprise application package lifecycle across three principal customer journeys such as migration, implementation, and maintenance. This tri-phase coverage enables the proposed platform to function as a unified AI-driven platform capable of managing transformations, deployments, and ongoing optimization within complex enterprise ecosystems.

During the migration phase, the proposed platform facilitates the usability of legacy systems and supports reengineering activities necessary to transition existing configurations, customizations, and codebases to modern SaaS or cloud-native environments. The proposed platform performs fit-to-gap and fit-to-standard analyses, automatically identifying deviations between the legacy implementation and target platform best practices. Based on this analysis, the proposed platform generates configuration templates, migration scripts, and transformation logic required to ensure compliance with OEM standards while minimizing manual intervention.

In the implementation phase, the proposed platform assists in business process design and technical fitment assessment, mapping enterprise requirements to platform capabilities. Leveraging AI-based reasoning and knowledge graphs, it recommends optimal configurations, generates application components, and automates the associated configuration and development tasks necessary for a compliant, production-ready deployment. This accelerates the implementation lifecycle while ensuring alignment with organizational and OEM-specific standards.

The maintenance phase encompasses platform health checks, impact analysis, and the management of enhancements or upgrades, whether major or minor. The platform continuously monitors operational telemetry and identifies potential degradation or conflict introduced by new releases, patches, or feature integrations. Through automated dependency mapping and rule-based reasoning, the system predicts downstream impacts, recommends corrective actions, and generates required test cases or change scripts to preserve system stability and compliance.

In an example implementation, a global enterprise uses the platform to manage its transition from an on-premises SAP™ environment to SAP S/4HANA™. During the migration journey, the proposed platform ingests legacy configuration files and ABAP™ code, performs a fit-to-standard analysis, and generates transformation scripts that realign custom logic with S/4HANA conventions. Upon successful migration, the implementation journey begins, where the platform assists consultants in designing business workflows, validating integration points, and auto-generating extension modules aligned with SAP's clean-core principles. Subsequently, in the maintenance journey, the enterprise introduces a quarterly SAP update. The platform automatically performs a pre-upgrade impact analysis, detects incompatible configurations, and generates patch scripts along with regression test cases. Throughout all phases, audit logs capture the actions performed, ensuring full traceability across migration, implementation, and maintenance workflows. This example illustrates how the platform provides continuous, AI-driven lifecycle coverage across enterprise transformation journeys.

The proposed platform empowers enterprises, business analysts, developers, and testers with advanced capabilities in document analysis, code generation, contextualized chat, and integration with enterprise systems like SAP, ServiceNow, and Salesforce.

The proposed method employees cutting-edge AI models including third-party hosted (e.g., GPT-4.1 nano (OpenAI), Mistral large-latest or the like), and locally deployed (e.g., Llama 3.2 via Ollama or the like). These models are used to power features such as contextual code understanding, test case generation, and intelligent documentation workflows.

In an embodiment, the proposed platform incorporates a comprehensive fairness and bias mitigation framework coupled with an explainability and transparency layer, ensuring that all AI-driven operations and outputs adhere to enterprise standards of ethics, accountability, and traceability.

Under the fairness and bias mitigation mechanism, the platform implements multi-tiered guardrails designed to detect, suppress, and neutralize any form of profane, toxic, or biased content generated during AI inference or user interaction. Each AI output is dynamically evaluated for contextual relevance to the specific client environment or project scope, ensuring that model responses remain aligned with enterprise policy and domain constraints. To enhance reliability, the system incorporates self-healing reflection agents that continuously review and validate AI-generated artifacts, such as code snippets, configuration recommendations, or documentation. When inconsistencies or deviations from expected logic patterns are detected, these agents automatically perform corrective actions, re-executing generation loops until the output satisfies predefined accuracy and compliance thresholds.

The explainability and transparency layer enhances user trust and governance through real-time monitoring and traceability of AI decision processes. The system integrates AI observability services that continuously trace, log, and visualize multi-agent decision flows, providing visibility into how individual agents, such as discovery, development, or testing agents, contribute to a composite outcome. Furthermore, the platform employs Retrieval-Augmented Generation (RAG) as the default grounding strategy, ensuring that AI responses are supported by trusted, domain-specific content repositories. This grounding technique links generated outputs to their original data sources, thereby improving transparency, reducing hallucinations, and facilitating validation by enterprise reviewers. Collectively, these explainability features enable auditable AI operations, where every model decision, data retrieval, and transformation is traceable through structured logs and versioned knowledge assets.

In an example implementation, the proposed method integrator uses the platform to auto-generate configuration scripts for a cloud migration project. During generation, the fairness and bias mitigation guardrails evaluate the output for inappropriate or toxic language and suppress it before display. The context validator ensures that generated scripts reference only the customer's approved libraries and not external sources. When the reflection agent identifies inconsistent variable mapping between modules, it automatically triggers a self-healing loop that regenerates and revalidates the affected code segment until convergence is achieved. Simultaneously, the explainability module logs each agent's contribution, showing, for instance, how the discovery agent identified legacy dependencies and how the developer agent refactored them for the target platform. Through RAG-based grounding, the generated recommendations are linked directly to the customer's internal configuration repository, allowing auditors to trace each parameter back to a verified source. This example illustrates how the system ensures fair, bias-mitigated, explainable, and fully auditable AI-driven operations across enterprise transformation workflows.

Data Privacy & Security, the proposed method does not collect or process personally identifiable information (PII) or other sensitive data. Accordingly, advanced encryption or anonymization mechanisms are not required at this stage.

Accountability & Human Oversight: Human-in-the-loop processes are embedded in document generation and code output phases. The users are encouraged to review, modify, or reject AI output before acceptance. The reflection agents act as an additional safeguard by validating and correcting generated content autonomously.

AI Risk Assessment: The proposed platform adopts a pragmatic approach to assessing and mitigating AI-related risks throughout the development lifecycle. Rather than isolating risk evaluation to a single stage, the proposed platform embeds risk thinking into every phase, from design to deployment.

The proposed platform categorizes the AI risks across dimensions such as: output integrity (e.g., inaccuracies, hallucinations or the like), user safety and experience (e.g., toxicity, contextual misalignment or the like), operational reliability (e.g., unintended behavior, agent errors or the like), and misuse potential (e.g., over-reliance or adversarial prompts).

While specific mitigations are detailed in other sections of this policy, the purpose of this assessment is to ensure continuous visibility into AI behavior. Each new feature or workflow involving AI is evaluated against these risk dimensions as part of our internal quality and testing pipeline. As the platform evolves, the platform aim to formalize this assessment process further, aligning with leading frameworks such as ISO/IEC 42001 and the NIST AI Risk Management Framework.

In an embodiment, the proposed platform implements a comprehensive testing and reliability assurance framework designed to ensure the stability, reliability, and integrity of all AI-powered services throughout their lifecycle. The proposed platform integrates automated testing, continuous integration, containerized deployment, and pre-deployment validation mechanisms to uphold enterprise-grade enterprise application package assurance and operational consistency.

The proposed platform employs automated test coverage across all core microservices and AI modules using PyTest-based unit and integration testing. Each service undergoes rigorous validation to confirm expected functional behavior, detect regression anomalies, and prevent unintended or non-deterministic outputs. Test results are programmatically analyzed to identify logical inconsistencies or performance degradations, ensuring that no unverified code propagates into the deployment pipeline.

The Continuous Integration (CI) layer is orchestrated via GitHub Actions (for example), which automatically triggers the complete test suite on every code change, branch update, or pull request. This mechanism enforces continuous code hygiene and early-defect detection, reducing human dependency in testing cycles. The CI workflow integrates with code coverage and static analysis tools to ensure adherence to both coding standards and functional reliability metrics.

For deployment consistency, the proposed platform adopts containerized deployments wherein all services are encapsulated in docker containers. This ensures environmental reproducibility across development, staging, and production ecosystems. The use of containerized environments guarantees that dependencies, runtime configurations, and library versions remain identical across environments, eliminating “works on my machine” discrepancies that can lead to production instability.

Prior to release, the proposed platform performs Pre-deployment validation using both synthetic test data and real-world scenarios that simulate enterprise workloads. Critical AI workflows, including multi-agent orchestration flows, reasoning pipelines, and code generation modules, are stress-tested under varying conditions to validate correctness, convergence behavior, and performance thresholds. Any anomaly detected during these tests triggers automated rollback and root-cause analysis workflows, ensuring that only stable and validated builds are deployed to production.

Collectively, these testing and reliability practices embody platform commitment to responsible AI engineering, reducing operational risk while ensuring that every deployed feature meets reliability, reproducibility, and ethical compliance benchmarks.

In one example implementation, a development team introduces a new agent module for automated test case generation within the platform. Upon submitting a pull request, GitHub Actions automatically initiates a CI pipeline, executing PyTest cases that verify both unit-level logic and integration with the existing reasoning engine. During testing, a regression is detected in one of the dependency handlers; the CI process blocks the merge and reports the issue for correction. After rectification, the service is containerized into a Docker image and deployed in a staging environment identical to production. There, pre-deployment validation runs synthetic test scenarios mimicking enterprise configurations and real project data to assess AI output accuracy and consistency. Once all validation thresholds are met, the module is promoted to production without human intervention. This example illustrates how platform automated testing and deployment framework ensures reliability, minimizes risk, and delivers continuously verified AI-driven functionalities.

Commitment to Responsible AI: The proposed platform recognizes the ethical responsibility that comes with deploying advanced AI. While the proposed platform prioritizes performance and productivity, proposed platform strives to evolve toward inclusive, secure, and transparent AI practices.

The proposed platform provides a comprehensive security strategy that addresses threats across the application, data, and infrastructure layers, ensuring defense in depth.

Web Application Security: We implement robust controls to prevent common web attacks, including secure session management using HttpOnly and SameSite cookies, regenerating session IDs after login, and enforcing short timeouts. Cross-Site Scripting (XSS) is prevented through stringent output sanitization and escape, complemented by Content Security Policy (CSP).

SQL/NoSQL Injection is blocked by using parameterized queries and strictly validating/sanitizing inputs, including JavaScript object-oriented programming library (e.g., Mongoose schemas or the like) for MongoDB. All communications are secured by enforcing HTTPS site-wide with modern TLS (v1.2 or v1.3) and HSTS headers.

Database Security (MongoDB Atlas): Access to our databases is strictly controlled via IP whitelisting, mandatory TLS encryption, and the application of least-privilege Role-Based Access Control (RBAC) roles. We ensure environmental isolation (e.g., dev vs. prod) and continuous monitoring with alerts5.

File Upload Security: We ensure the integrity and safety of uploaded files by whitelisting MIME/file types, enforcing file size limits, and scanning files for malware (e.g., AWS GuardDuty) before processing. All files are stored in private, encrypted buckets (SSE-S3 or SSE-KMS) and accessed securely using pre-signed URLs.

AI Service Security: We proactively secure our AI services against novel threats, including prompt injections by separating and sanitizing inputs, and filtering model outputs using a tool named “PomptMap”. Code/execution attacks are prevented by avoiding eval() and using sandboxed execution environments (e.g., Docker) with dropped container privileges. Denial of Service (DoS) attacks are mitigated through rate limiting by API key/IP and capping payload sizes/execution times. API access is secured using an API gateway, enforcing strong authentication (JWT or OAuth2), HTTPS, and regular API key rotation.

### Perimeter & Network Security (AWS EC2/Kubernetes)

Our cloud infrastructure is secured by strict network access controls (Security Groups, Network ACLs), ensuring only necessary ports are open to restricted IP ranges. We enforce the use of IMDSv2 for secure instance metadata access9 and manage Kubernetes exposure through ALB Ingress Controllers to avoid open Node Ports. Least-privilege IAM roles are universally applied, utilizing tools like IAM Access Analyzer and IRSA for fine-grained permissions in EKS10. We employ AWS WAF for L7 filtering, AWS Shield for DDoS protection, and enforce modern TLS (1.2/1.3)410.

Continuous monitoring and scanning is enabled for both web and backend

### Guidelines for AI Related Development and Data Storage

In the context of AI, protecting sensitive data and Personally Identifiable Information (PII) is paramount. Our approach specifically focuses on preventing data from ever being unintentionally exposed or processed insecurely. We implement strict practices to never include secrets directly in prompt templates. This ensures that confidential information, such as API keys or specific sensitive user data, is not embedded into the instructions given to the AI model.

Furthermore, we apply redaction or hashing to inputs and outputs. This technique modifies or masks sensitive portions of data, such as PII, before they are fed into the AI model or before the model's output is displayed to users. For example, PII could be replaced with placeholder values or one-way hashed to prevent its direct exposure8. This dual approach ensures that sensitive data is neither inadvertently processed by the AI in its raw form nor leaked through its responses.

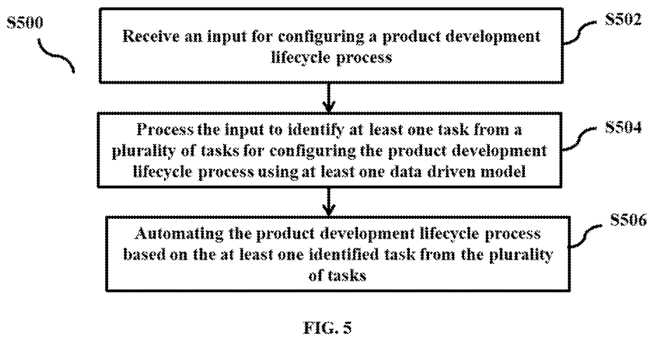

FIG. 5 is a flow chart (S500) illustrating a method for handling automatic product development lifecycle process, according to embodiments as disclosed herein.

At S502, the method includes receiving the input for configuring the product development lifecycle process. At S504, the method includes processing the input to identify the at least one task from the plurality of tasks for configuring the product development lifecycle process using at least one data driven model. At S506, the method includes automating the product development lifecycle process based on the at least one identified task from the plurality of tasks.

The various actions, acts, blocks, steps, or the like in the flow chart (S500) may be performed in the order presented, in a different order or simultaneously. Further, in some embodiments, some of the actions, acts, blocks, steps, or the like may be omitted, added, modified, skipped, or the like without departing from the scope of the invention.

The various actions in method may be performed in the order presented, in a different order or simultaneously. Further, in some embodiments, some actions listed in figures may be omitted.

The embodiments disclosed herein can be implemented through at least one software program running on at least one hardware device and performing network management functions to control the elements. The elements shown in figures can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method for handling automatic product development lifecycle process, comprising:
receiving, by an electronic device, an input for configuring a product development lifecycle process;
processing, by the electronic device, the input to identify at least one task from a plurality of tasks for configuring the product development lifecycle process using at least one data driven model; and
automating, by the electronic device, the product development lifecycle process based on the at least one identified task from the plurality of tasks.

2. The method as claimed in claim 1, wherein the method comprises:
receiving, by the electronic device, a feedback about the product development lifecycle process over a period of time, wherein the feedback corresponds to a user-action;
finetuning, by the electronic device, the feedback about the product development lifecycle process with respect to a user context; and
automating, by the electronic device, the product development lifecycle process based on the finetuned feedback.

3. The method as claimed in claim 1, wherein processing, by the electronic device, the input to identify the at least one task from the plurality of tasks for configuring the product development lifecycle process using the at least one data driven model comprises:
obtaining, by the electronic device, a range of conversation, a legacy system technique base information, client interaction information, a design documentation information, and a product variant as an input to the at least one data driven model;
summarizing, by the electronic device, the information comprising the range of conversation, the legacy system technique base information, the client interaction information, the design documentation information, and the product variant;
creating, by the electronic device, a Small-Language-Model (SLM) based on the summarized information using a knowledge repository;
training, by the electronic device, the SLM with at least one configuration to develop at least one recommendation for system configuration; and
processing, by the electronic device, the input to identify the at least one task from the plurality of tasks for configuring the product development lifecycle process using the SLM and the at least one recommendation.

4. The method as claimed in claim 1, wherein processing, by the electronic device, the input to identify the at least one task from the plurality of tasks for configuring the product development lifecycle process using the at least one data driven model comprises:
receiving, by the electronic device, at least one structured input comprising at least one of: at least one due-diligence assessment report, at least one application health scan report, and at least one process assessment report;
receiving, by the electronic device, at least one semi-structured input comprising at least one of: at least one technique-base, at least one library file, and an application configuration detail;
receiving, by the electronic device, at least one unstructured input comprising at least one of: business workshop discussion;
training, by the electronic device, the at least one structured input, the at least one semi-structured input, the at least one unstructured input on a knowledge base to produce an input database using the at least one data driven model;
validating, by the electronic device, the input database against the trained knowledge base; and
producing, by the electronic device, at least one of: at least one design artifact and at least one industry aligned design asset in the form of: at least one of: at least one business requirement document, at least one business process document, and at least one business process master list.

5. The method as claimed in claim 1, wherein processing, by the electronic device, the input to identify the at least one task from the plurality of tasks for configuring the product development lifecycle process using the at least one data driven model comprises:
receiving, by the electronic device, at least one structured input comprising at least one of: at least one due-diligence assessment report, at least one application health scan report, and at least one process assessment report;
receiving, by the electronic device, at least one semi-structured input comprising at least one of: at least one technique-base, at least one library file, and an application configuration detail;
receiving, by the electronic device, at least one unstructured input comprising at least one of: business workshop discussion;
training, by the electronic device, the at least one structured input, the at least one semi-structured input, the at least one unstructured input on a knowledge base to produce an input database using the at least one data driven model;
validating, by the electronic device, the input database against the trained knowledge base;
generating, by the electronic device, a code base that mimics a life of a developer by generating the code, compiling code, resolving issues and producing a tested code as per a best practices recommended by an original equipment manufacture (OEM), wherein the electronic device comprises self-reflection and self-consistency written technique that assists in eliminating hallucinations and produce accurate code every time, wherein a code-generation functionality assists in auto-remediation of legacy code-base and migrates legacy custom objects to cloud-native code-base for modernization.

6. The method as claimed in claim 5, wherein the method comprises:
detecting and suppressing, by the electronic device, at least one of: a profanity content and a toxic content using a guardrail; and
validating, by the electronic device, the code base for relevance to client-specific context, and wherein a self-healing reflection agent reviews and auto-corrects a data driven model generated code when inconsistencies of the data driven model generated code are detected.

7. The method as claimed in claim 5, wherein the code-generation functionality provides a copilot assistance in the view of conversational artificial intelligence (AI) and assisting a developer configure a system with a guided step.

8. The method as claimed in claim 5, wherein the method comprises creating, by the electronic device, at least one of: a test case and a synthetic test data that expedites a testing cycle based on at least one of: at least one produced design artifact, at least one produced industry aligned design asset, the code base, and the code-generation functionality.

9. The method as claimed in claim 1, wherein the electronic device combines an event-driven serverless computing, a secure document handling, an adaptive access control, and real-time monitoring, so as to ensure elastic scalability while maintaining strict security and compliance guarantees.

10. The method as claimed in claim 1, wherein the electronic device has at least one of: a context-aware multi-tab session isolation feature, a hybrid login enforcement feature, a dynamic cost tracking feature, and a malware-aware file quarantine feature, wherein the context-aware multi-tab session isolation feature detects and differentiates user sessions opened across multiple browser tabs or devices, maintaining independent security and state contexts for each, so as to prevent cross-tab data leakage or command interference, and preserve an integrity of concurrent workflows, wherein the hybrid login enforcement feature triggers an Multi-Factor Authentication (MFA) verification, and wherein the malware-aware file quarantine feature inspects all uploaded files using heuristic and AI-based scanning models prior to ingestion.

11. The method as claimed in claim 1, wherein the electronic device processes the input to identify the at least one task from the plurality of tasks for configuring the product development lifecycle process using the at least one data driven model without affecting at least one of: privacy associated with a customer data and confidentiality associated with customer data.

12. The method as claimed in claim 1, wherein the electronic device has a Retrieval-Augmented Generation (RAG) to ground responses in trusted, domain-specific content repository, wherein the RAG enables a transparency by linking responses to at least one original data source and validation and traceability for a user.

13. The method as claimed in claim 1, wherein the method comprises implementing, by the electronic device, a web application security, wherein the web application security comprises at least one of:
secure session management using Hypertext Transfer Protocol (HTTP) and SameSite cookies, regenerating at least one session identifier after user authentication, and enforcing a short session timeout to control an unauthorized access risk;
controlling a cross-site scripting attack by applying stringent output sanitization and escaping techniques, and enforcing a Content Security Policy (CSP) to restrict an execution of an untrusted script;
controlling at least one of: Structured Query Language (SQL) and NoSQL injection attacks by utilizing at least one parameterized query and validating and sanitizing all user inputs, including the enforcement of strict schema validation through JavaScript object-oriented programming library for a database; and
securing all client-server communication by enforcing HTTPS across the entire site, using a Transport Layer Security (TLS) protocol and implementing a HTTP Strict Transport Security (HSTS) header to prevent a downgrade attack.

14. The method as claimed in claim 1, wherein the product development lifecycle process comprises at least one of: process scop generation, process scop assessment, requirement gathering process, a business requirement document (BRD) creation process, a fit to product configuration process, creating configuration document, Identify a gap between a business requirement and standard configuration, detailing customization requirement, configuring the product platform, creating a functional specification, creating a technical specification, development of a workflow, development of a reports, development of integration, development of conversion, development of enhancements, creating training manual process, conducting training process, creating test scripts, performing unit testing, performing systems integration testing, performing user acceptance testing, Conversions of Data, Data migration process, cutover process, a Go-Live process, a user story creation process, a process flow diagram generation process, a meeting minutes standardization process, a chat-based question answer (Q&A) assistant process, configuration automation process, a technique simulation attempting process, test simulation attempting process, a migration process, an implementation process and a maintenance process.

15. The method as claimed in claim 14, wherein BRD creation process is generated by:
scanning and reading at least one of: at least one business process document, at least one standard operating procedure, and at least one consultant workshop note;
extracting and transcribing business requirements from at least one of: at least one written material, at least one imaged material, and at least one recorded material;
generating a business requirements relevant to a customer and corresponding platform; and
creating, refining and assembling a business requirements document (BRD) by through a chat interface.

16. The method as claimed in claim 14, wherein the fit-to-gap analysis is performed by:
comparing a user generated requirement with a standard configuration guide;
identifying configuration sequences and dependencies; and
generating the fit-to-gap analysis.

17. The method as claimed in claim 1,
wherein an access to the databases is controlled via at least one of: an internet protocol (IP) whitelisting, a mandatory Transport Layer Security (TLS) encryption, and an application of a least-privilege Role-Based Access Control (RBAC) role;
wherein a Denial of Service (DoS) attack is mitigated through rate limiting by at least one of: an Application Programming Interface (API) key and an internet protocol (IP) key and capping at least one of: a payload size and payload execution time;
wherein the API access is secured using an API gateway, enforcing strong authentication, HTTPS, and regular API key rotation;
wherein the electronic device secures a cloud infrastructure by implementing a strict network access control through a Security Groups and Network Access Control List (ACL), so as to ensure that only necessary ports are open and that access is restricted to approved IP address ranges;
wherein the electronic device enforces a use of Instance Metadata Service Version 2 (IMDSv2) for secure access to instance metadata, and managing Kubernetes cluster exposure through Application Load Balancer (ALB) Ingress Controllers to eliminate open NodePorts and minimize attack surface;
wherein least-privilege Identity and Access Management (IAM) roles are applied across all resources, to enforce fine-grained access control in an Elastic Kubernetes Service (EKS) environment; and
wherein the electronic device employs an AWS Web Application Firewall (WAF) for Layer 7 traffic filtering, implementing AWS Shield for Distributed Denial of Service (DDoS) protection, and enforcing secure communications through modern Transport Layer Security (TLS) protocols.

18. The method as claimed in claim 1, wherein security and governance are enforced through a multi-layered architecture incorporating OAuth2/JWT-based authentication, role-based access control, and tenant-level isolation to ensure strict separation of customer data.

19. The method as claimed in claim 1, wherein the electronic device incorporates a continuous self-learning adaptation subsystem that captures, processes, and applies post-generation user feedback and implicit interaction signals to modify subsequent document or code generation behavior, wherein feedback artifacts are normalized into structured semantic deltas through intent parsing, topic classification, and transformation-pattern extraction, wherein in parallel, the electronic device records comprehensive audit-trail telemetry for all user operations, including edits, regeneration triggers, rejection events, and contextual constraints applied during the interaction, wherein an operational history persisted within a NO-SQL knowledge state layer and indexed against output variants, domain context, and OEM-specific configuration attributes, wherein a reinforcement logic engine synthesizes explicit feedback and implicit operational signals into an adaptive generation profile, which is automatically injected into future inference prompts, decision policies, and agent-level orchestration sequences.

20. An electronic device for handling automatic product
development lifecycle process, comprising:
a processor;
a memory; and
a product development lifecycle process automation controller, coupled with the processor and the memory, configured to:
receive an input for configuring a product development lifecycle process;
process the input to identify at least one task from a plurality of tasks for configuring the product development lifecycle process using at least one data driven model; and
automate the product development lifecycle process based on the at least one identified task from the plurality of tasks.
